(19) United States
(12) Patent Application Publication
(10) Pub. No.: US 2012/0016746 A1
(43) Pub. Date: Jan. 19, 2012

(54) Method And System For Computer-Based Network Advertising

(76) Inventors: Justin H. Rockwell, Longs, SC (US); Pamela O. Rockwell, Longs, SC (US)

(21) Appl. No.: 13/180,591

(22) Filed: Jul. 12, 2011

Related U.S. Application Data
(60) Provisional application No. 61/365,238, filed on Jul. 16, 2010.

(51) Int. Cl. G06Q 30/00

(52) U.S. Cl. 705/14.61

(57) ABSTRACT

A computer-based method of advertising products and services for communication to an electronic device user, the method includes the steps of receiving a message-value from an electronic device, matching the message-value to a staggered electronic marketing campaign, creating a subscriber data profile corresponding to the mobile electronic device associated with the staggered electronic marketing campaign, confirming receipt of the message value, and sending campaign advertisements to the electronic device.

### RELATED APPLICATIONS

This application claims the benefit of U.S. Provisional Application No. 61/365,238 filed on Jul. 16, 2010.

### BACKGROUND OF THE INVENTION

1. Field of the Invention

The present invention relates generally to computer-network based electronic advertising to electronic devices, preferably, wireless devices such as cellular telephones and the like.

2. Description of the Related Art

Advertising is typically defined as a form of communications designed to induce people to purchase or take some action to draw favor upon products, goods or services. Advertising may include the name of a product, good or service and how the product, good or service could benefit a consumer or to persuade a targeted market of people to purchase a particular product brand. Brands may be paid for, or identified, through sponsors and viewed through various media, for example, newspapers, radio, television, and electronic advertising via the World Wide Web (“internet”). Advertising may also serve to communicate an idea to a group of people to convince them to take a certain action, such as encouraging particular behaviors in consumption.

Consumers often find it problematic to learn about and find value-oriented opportunities of interest such as those related to personal-choice dining, entertainment events, consumer goods and the like. Further, finding opportunities in different geographic markets, or areas, in a timely fashion, presents additional informational problems for consumers. These problems are exacerbated when a consumer travels to unfamiliar places, often during extended stays, while on leisure travel, business trips and the like. This situation can be even more problematic when traveling for holidays, vacations and the like where local market demand for goods and services varies from day to day. Accordingly, consumers waste time seeking opportunities instead of enjoying themselves, often leading to personal frustration. Understandably, consumers do not desire being bombarded with endless advertising of any fashion and likely will only be responsive to opportunities that generally have some modicum of personal interest.

Hence, it would be advantageous for any advertising system to incorporate a variety of options for the consumer, including, obtaining additional information or terminating advertising. Ultimately, when the consumer can easily terminate advertising or does not have to positively act to eliminate the advertising, to some degree, the desirability of receiving advertisements may increase.

Advertisers generally seek increased consumption of their products, goods and/or services when promoting them. Thus, advertisers naturally desire to connect with consumers and provide opportunities for goods and services in easy-to access and useful ways. For example, advertisers in resort areas especially desire to connect with travelers and visitors who arrive and stay for relatively short lengths of time, e.g. several days or weeks at most. Accordingly, advertisers desire to provide knowledge of opportunities for goods and services when that information is most likely to result in consumption.

Further, advertisers also wish to retain the consumer's attention to further increase consumption. Advertising resources may be optimized when the consumer's desires can be fulfilled with up-to date opportunities and information regarding goods and services. It will be apparent to those in the advertising arts that consumer opportunities occur at various times in the future and that current advertising is easily forgotten without further stimulus and reinforcement.

The volume of electronic device-based advertising and messaging has increased significantly over recent years. In unsolicited form, this kind of electronic advertising is often referred to as “spam” and is considered a nuisance by many consumers. Spam is most often broadcast indiscriminately to email accounts, web addresses, and telephones such as home bound receivers, mobile or portable cellular-based telephones, pagers, digital hand-held devices (PDA) and the like. In particular, devices such as portable hand held devices, for example cellular telephones, are a desirable destination for spam advertising, but consumers generally consider personal devices somewhat forbidden and off-limits to advertisers. Thus, an advertiser's access to cell phone addresses/phones tends to be limited when using spam-based advertising campaigns. In contrast, more recent electronic advertisement systems employ an initial “awareness advertisement”, for example, print messages on/in a brochure, menu, billboard, radio or television advertising or internet and the like. The awareness advertisement typically uses a contact telephone number and/or message such as an “instant message”, “text message” or email message stimulus sent by a consumer using a specific code or message/keyword to connect with the advertiser. The advertiser then electronically responds to the consumer by sending a short message or email or response code in return. For example, a consumer sees a magazine advertisement “Text GOLF to 01593 for discounts”. The consumer then sends a text message to 01593 and typically (generally, almost immediately) receives a return text message from the advertiser containing an advertisement providing specific information concerning a consumer discount somehow related to the game of golf.

Another type of electronic advertising is a so-called “scheduled advertising”, where, for example, the device/telephone sending the text message requesting advertising is added to a regular schedule: a single message is repetitively sent to telephones having been added to the particular network sending the advertisement. In practice, the same message is sent repeatedly until it is terminated by the phone owner or the advertiser. In many circumstances, individuals may not see the message for hours or days depending on the advertising frequency. Consequently, the timeliness of the advertising may be completely lost and the consumer disinterested in receiving the advertising information or frustrated with the message repetition. In either case, it would be advantageous if electronic advertising were timelier, less intrusive and more directly applicable to a consumer's interests and desires. It would also be advantageous if a consumer received all messaging that was sent by an advertiser. However, individuals joining a network after a given time will not necessarily receive past messages unless the messages are repeated by the particular marketing campaign, and then, all persons associated with the network will receive the same message at the same time. Accordingly, unless consumers join the network at the same time, they will not receive the same advertising message for a given offer at the same time in the future. Further, prior art messaging systems are generally designed so that messages scheduled for future delivery are delivered at specific times. If multiple messages were desired then a multiplicity of messaging campaigns would also be required, and potential subscribers would have to join to each individual campaign to receive all advertisements. In other words, a consumer must join each desired campaign to receive each specific advertisement by adding their device to each network supporting a given marketing campaign. It can be appreciated that virtually no consumer will likely spend the time to engage in such behavior. Further, advertisers are not likely to spend scarce resources with unknown probability of market penetration given the time and costs for network resources, programmer time and the like. Finally, in the unlikely event that consumers joined multiple advertising campaigns to obtain a variety of offers, the receipt of numerous messages day after day are likely to cause consumers to become irritated and even dissatisfied causing the consumer to quit a network sooner. Thus, marketers lose customer confidence, market penetration, and sales conversions.

Accordingly, there is a long felt need to provide consumers with electronic advertising in a quick, easy, and efficient manner that provides market penetration by the advertiser without consumers feeling their time is being intruded. The development of the system, method and product for electronic consumer advertising for potential revenue enhancement to advertisers and marketers of products, goods, and services fulfills this need.

A search of the prior art did not disclose any patents that read directly on the claims of the instant invention; however, the following references were considered related:

U.S. Pat. No. 6,889,054 B2, issued in the name of Himmel et al.;

U.S. Pat. No. 6393274 B1, issued in the name of Peltonen;

U.S. Pat. No. 6,119,095, issued in the name of Morita;

U.S. Pat. No. 6,836,667 B1, issued in the name of Smith, Jr.;

U.S. Pat. No. 7,027,801 B1, issued in the name of Hall et al.;

U.S. Pat. No. 7,116,977 B1, issued in the name of Moton, Jr. et al.;

U.S. Pat. No. 7,152,038 B2, issued in the name of Murashita et al.;

U.S. Pat. No. 7,194,417 B1, issued in the name of Jones;

U.S. Pat. No. 7,328,004 B1, issued in the name of Wolters et al.;

U.S. Pat. No. 7,369,864 B2, issued in the name of Vaananen;

U.S. Pat. No. 7,379,891 B1, issued in the name of Donner et al.;

U.S. Pat. No. 7,526,278 B2issued in the name of Link, II et al.;

U.S. Pat. No. 7,548,754 B2, issued in the name of Shivaram et al.;

U.S. Pat. No. 7,581,196 B2, issued in the name of Sato et al.;

U.S. Pat. No. 7,684,790 B2, issued in the name of Cartmell;

U.S. Pat. No. 7,706,517 B1, issued in the name of Todd;

U.S. Pat. No. 6,178,331 B1, issued in the name of Holmes et al.;

U.S. Pat. No. 6,505,046 B1, issued in the name of Baker,

U.S. Pat. No. 6,647,269 B2, issued in the name of Hendrey et al.;

U.S. Patent Application No. 2005/0114167 A1, published in the name of McEvoy;

U.S. Patent Application No. 2009/0228361 A1, published in the name of Wilson;

U.S. Patent Application No. 2010/0015993 A1, published in the name of Dingier et al.;

U.S. Patent Application No. 2009/0233584 A1, published in the name of Watson et al.;

U.S. Pat. No. 6,901,261 B2, issued in the name of Banatre et al.;

U.S. Pat. No. 7,016,689 B2, issued in the name of Clark et al.;

U.S. Pat. No. 7,043,235 B2, issued in the name of Meyer et al.;

U.S. Pat. No. 7,058,594 B2, issued in the name of Stewart;

U.S. Patent Application No. 2011/0124399 A1, published in the name of Dutilly, Derek et al.; and

U.S. Patent Application No. 2011/0109720 A1, published in the name of Smolic et al.

Consequently, a need has been felt for a computer-based method and system of advertising products and services to an electronic device. This application presents claims and embodiments that fulfill a need or needs not yet satisfied by the devices, inventions and methods previously or presently available. In particular, the claims and embodiments disclosed herein describe a computer-based method and system of advertising products and services to an electronic device, the system comprising: a communications network accessible by an electronic device; a campaign application server connected by a communications link to a communications network; and a marketing application program residing on the campaign application server, the marketing application program comprising at least one staggered electronic marketing campaign control program configured to execute a staggered electronic marketing campaign. The computer-based method and system of advertising products and services to an electronic device of the present invention providing unanticipated and nonobvious combination of features distinguished from the software, devices, inventions and methods preexisting in the art. The applicant is unaware of any software, device, system, method, disclosure or reference that discloses the features of the claims and embodiments disclosed herein.

### SUMMARY OF THE INVENTION

Briefly described according to one embodiment of the present invention, a system, method and product for electronic consumer advertising for potential revenue enhancement to advertisers and marketers of products, goods and services is disclosed. The present invention can be used to connect content providers (“advertisers”) with network operators, preferably wireless network operators, with consumers using electronic communications, in particular wireless communication networks.

In accordance to one embodiment of the invention, there is provided a computer-based method for advertising products and services to an electronic device user. The method comprises the steps of: receiving a message-value from an electronic device; matching the message-value to a corresponding staggered electronic marketing campaign; creating a subscriber data profile corresponding to the mobile electronic device associated with the staggered electronic marketing campaign; confirming receipt of the message-value by sending a confirmation message to the electronic device; sending campaign advertisements contained in the staggered electronic marketing campaign to the electronic device; and terminating contact with the electronic device at the end of the staggered electronic marketing campaign.

In accordance to another embodiment of the invention, there is provided a computer-based system for providing advertising to an electronic device user. The system comprises: a communications network accessible by an electronic device;

a campaign application server connected by a communications link to the wireless communications network; and a marketing application program residing on the campaign application server, the system further comprising at least one staggered electronic marketing campaign control program configured to execute a staggered electronic marketing campaign.

In accordance to another embodiment of the invention, there is provided a computer program product for delivering an electronic marketing campaign on a network. The program comprises a computer readable storage medium having a computer readable program code embodied thereon. The code is divided into a plurality of modules, the modules comprising; (a) a subscriber data module for receiving and storing subscriber information; (b) a staggered electronic marketing campaign module, (c) a query-script module; and (d) a campaign data output module for sending a staggered electronic marketing campaign to a subscriber.

The above-described embodiments along with additional features and advantages of certain preferred embodiments of the invention will be disclosed hereinbelow.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a block diagram of a staggered campaign method of the system described herein, according to one embodiment of the present invention;

FIG. 2 is a schematic showing an exemplary staggered campaign computer and network system for delivering a staggered advertising campaign, in accordance to one embodiment of the present invention; and

FIG. 3 is illustrates a diagram of a computer readable medium comprising a staggered marketing campaign, according to one embodiment of the present invention.

### DESCRIPTION OF THE PREFERRED EMBODIMENT

### Detailed Description of the Figures

The present invention generally relates to electronic network communications. More specifically, the present invention relates to marketing campaigns (“advertising”) offered via electronic communications systems, for example, the World Wide Web (Web), cellular telephone communications networks and the like. For the purposes of the present disclosure, “advertising” is given its conventional and accepted general meaning of, “providing information, publicizing, making known or public, announcing, broadcasting, proclaiming, attracting, promoting or marketing goods and services from suppliers (”marketers“) to consumers of goods and services.” Further, for the purposes of the present disclosure, “electronic advertising” is advertising that is provided over any electronic communications network (“ECN”), preferably a wireless network, to a wireless device, preferably a mobile or cellular wireless telephone. Examples of basic electronic advertising include using computers connected to electronic communications networks.

For the purposed of this disclosure, an electronic staggered marketing campaign, or staggered marketing campaign (“SMC”) is defined as an electronic network-based marketing campaign that delivers to an electronic device, such as a cellular telephone, a group of two or more advertising offers for goods and services (“advertisements”) in a sequence, preferably a predetermined sequence, over a specified time period, for example, hours, days, weeks, etc. The advertising offers may be random, specific, related or non-related. The advertising may incorporate some traditionally known psychological factors used in mass media marketing or individual advertising, or not. Preferably, the advertisements are entirely predetermined to a large degree prior to the initiation of the SMC. Preferably, the SMC is employed in a specific, often limited, geographic area such as a resort town or area, a city or town, or other somewhat localized geographic region. Examples of the kinds or types of messaging over ECN useful for electronic marketing and in particular staggered marketing campaigns include but are not limited to Short Text Message Systems (“SMS systems” or “SMS”), so-called mixed or multimedia messaging systems (“MMS”), “instant” messaging systems via internet portal providers (e.g. Yahoo™ Instant Messaging), electronic mail systems (“Email”) and the like, that offer marketers of goods and services opportunities for market penetration to the public.

Short Message Service (SMS) text messaging is well known as the conventional text communication service component of (mobile) communication systems, using standardized communications protocols that allow the exchange of short text messages between enabled electronic devices. SMS as used on modern handsets was originally defined as part of the well-known “Global Standards for Mobile Communications (”GSM″) series of standards in 1985 as a means of sending messages of up to 160 characters to and from GSM mobile handsets. Since then, support for these services has expanded to include other mobile technologies such as ANSI CDMA networks and Digital AMPS as well as satellite and landline networks between a variety of properly enabled devices. Typically, SMS messages are mobile-to-mobile text messages, though the standard supports other types of broadcast messaging. Any standard cellular telephone in a conventional electronic network can be used as an electronic device to send and receive messages according to the invention. Manufacturers of electronic devices, in particular, mobile or portable electronic devices, such as cellular telephones, include, but are not limited to Samsung, Rim, Benq, Kyocera, LG, Motorola, NEC, Phillips, Sanyo, Siemens, and Sony Ericsson. For the purposes of the present disclosure, the abbreviations (SMS, GMS, ANSI CDMA, AMPS, SMPT, TCP/IP) are heretofore given their usual and accepted meanings in the electronic communications art. For the purposes of the present invention, any electronic messaging system capable of supporting communications between a marketer of advertising and potential consumer of electronic advertising are considered systems useful within the scope of the invention. Accordingly, Email messaging from phones, as popularized by, for example, the RIM BlackBerry™ and other similar devices that use standard electronic mail protocols such as the well-known SMPT over the TCP/IP protocols are also considered within the scope of the present invention. Accordingly, marketers and advertisers are able to provide messaging instantly to potential customers over may different types of networks and electronic communications protocols and electronic devices as will be understood by those possessing ordinary skill in the art.

The present invention can be embodied as systems, methods, and/or computer program products. As will be understood by those of ordinary skill in the art regarding understanding the claimed invention, other embodiments of the present invention may become apparent and these embodiments are considered within the scope of the claimed invention. The present invention can be embodied in hardware and/or in software (including firmware, resident software, micro-code, etc.) as long as the meets and bounds of the claims are met.

Any programming language or operating system useful in electronic network communications can be used to produce programs, program product or system programs useful for the present invention. In preferred embodiments of the present invention, programming languages include, PHP™, particularly preferable is Version 5, ColdFusion™, Perl™, Objective-C™, Python™, Ruby™, JavaScript, Java™, C™, C++™, C#™, or ASP and the like. Preferably, in accordance to the preferred embodiment, the computer system runs on a Linux™ operating system, using PHP 5™ and MySQL 5™.

Preferably, the staggered marketing campaign program runs on any general purpose computer system. In preferred embodiments, the computer system is a commercially-available computer system that runs using a Linux™ operating system. Such commercially available computer systems can be purchased from Hewlett-Packard Company, 3000 Hanover Street, Palo Alto, Calif. 94304-1185, USA, Cisco Systems, Inc., 170 West Tasman Dr., San Jose, Calif. 95134, USA, or other manufacturer of general purpose computer systems. In other preferred embodiments, the computer system is a server-based system such as a Hewlett-Packard ProLiant™ computer system. In another preferred embodiment, the computer system is based on Intel™ Quad-Core Xeon™ computer microprocessor architecture. Other useful computer systems, known to those of ordinary skill in the art, will perform in an equivalent and suitable fashion as will be understood by those of ordinary skill in the art. The system can be based on a physical server system or a virtual server system as would be known to those of skill in the art. The computer system can be a stand-alone system or part of a shared system and functionalized with devices such as disk drives, memory units: internal or external, keyboards, printers, monitors and the like, as known in the computer arts. The system can be operated from a remote or local location as would be understood in the art.

There are several types of basic messages common to most electronic text message communication systems, wherein the types of basic messages include: 1) “auto response” messages which send a message in response to a specific single query; 2) “scheduled messages” where the same message is sent at a specific time each day or week or other regular time interval; and 3) so called “voting” response messages where network members are asked for a single response to a specific question. In each case, the owner of an electronic device, such as a cell phone inputs or texts a message (e.g. “txt GOLF to 20100”) to establish communications or communicate with a message sender and receives a response, generally immediately, in return. In some systems, when a consumer texts a message to a number, the consumer's device contact information is added to a marketer's database so a future message can be sent unless the consumer decides not to further participate in the marketing campaign. Removing one's phone from an electronic marketing campaign is referred to as “opting out” of an offer or network so as not to receive further messages. An opt-out option is legally required in many areas, but in practice many marketers make opting-out difficult.

Once an electronic device is added to a network, at some time in the future, such devices associated with that network may receive additional messages (“bulk messages”) with additional offers.

The terminology used herein for describing particular embodiments of the invention is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for purposes of brevity and/or clarity.

Broadly, the staggered electronic marketing campaign (or “staggered campaign”) eliminates the need for an individual consumer to join multiple advertising campaigns in order to receive a range of advertising offers. The staggered campaign provides advertising to a consumer based on a generally predetermined set or group of advertising offers, termed a campaign, wherein each consumer receives all of the offers in the campaign, regardless of when (that is, the specific time) the individual consumer joins a particular staggered campaign network. For use in the present disclosure, such an advertising campaign is termed a “staggered campaign” because no two consumers will receive the offers at the same time unless they have joined into the network running the staggered campaign at approximately the same time frame, as will be disclosed and illustrated below.

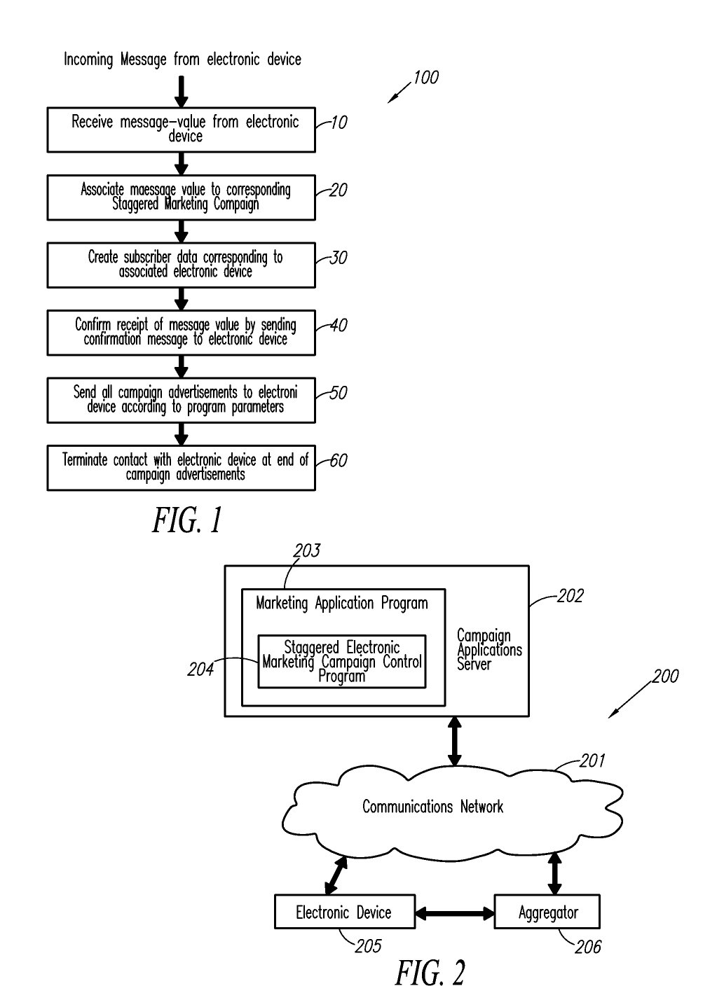

Referring now to FIG. 1, in accordance to one embodiment of the present invention, there is provided a method for advertising products and services to an electronic device user, preferably a portable or mobile electronic device, and most preferably, a mobile or portable cellular telephone. FIG. 1 illustrates a preferred embodiment method flow chart for a staggered electronic marketing campaign 100. In a first step 10 of the method flow chart 100, the staggered campaign program receives a message value from an electronic device, for example a cell phone, digital pager, personal digital assistant or other electronic device having an identifiable number, requesting advertising. The staggered marketing campaign program associates the message value with a related staggered electronic marketing campaign in a second step 20. The method next comprises a third step 30 which includes creating a subscriber/consumer data profile corresponding to the particular electronic device associated with the staggered electronic marketing campaign. A message acknowledging receipt of the message-value is sent to the electronic device confirming the message in a fourth step 40. Thereafter, the campaign advertisements are sent from the staggered electronic marketing campaign to the electronic device in a fifth step 50. Contact with the electronic device is terminated after all the advertisements in the campaign have been sent in a sixth step 60. In an especially preferred embodiment, the method includes the steps of updating campaign subscribers and sending campaign messaging on a regular interval by using campaign computer (or software) timing or clock function (referred to as a “chron”). The update time-period can be any desired interval and is not particularly critical, but typically relates to the specifics of a given staggered campaign. A particularly preferred time-period for updating campaign subscribers and sending campaign messaging is every fifteen minutes while running a campaign. Subsequently, the steps include retrieving message values and matching the retrieved message values to campaigns, determining which campaigns require sending messages to subscribers, getting the associated campaign details, getting the subscriber information associated with those campaigns requiring messages, and sending messages containing advertising.

In accordance to another especially preferred embodiment, each system chron or time update includes the method steps of retrieving the messages from subscribers, calculating the time when the campaign was joined by the individual subscribers, determining which campaigns require advertising to be sent, retrieving the individual campaign details, and sending the campaign advertisements to consumer s/subscribers. The particular order of these steps is not critical so long as the campaign objectives are achieved, but those of ordinary skill in the art will recognize that the computer and program resources required to program and run staggered marketing campaigns can vary, and each individual programmer may produce a unique program code to achieve the aspects of staggered marketing campaigns. The term “message value” means any message, code, or number used to identify the particular staggered campaign to the campaign computer and program or inform an electronic device user that they have been added to a campaign network. A “subscriber data profile”, for the purposes of this disclosure, means any and all information about the electronic device, the device user, or the advertising accessed that may be collected while the electronic device is connected to the campaign network. Data may include the contact phone number where a cellular phone is the device, personal data such as name, addresses, subscriber response times to campaigns, response rates, types of campaigns where responses are received, geographical information, and the like. The “advertisements”, “advertising” or “advertising offers” mean for the purposes of this disclosure any and all information regarding offers for goods and services that would be considered as advertising in any form of advertising.

In another embodiment, the method further comprises the step of sending advertising concomitantly with the network confirmation message. Some advertisers desire to connect to a maximum degree with consumers, hence, when a consumer joins a network seeking advertising the message value returned to a consumer can also contain advertising. The messages sent to and from a campaign and an electronic device can be in any form so long as both devices are in electronic communications with each other and the messages understandable by a consumer/subscriber. In a preferred embodiment, the method comprises communications to and from the mobile device user comprises short message service text messages of 160 characters or less, multimedia messaging service messaging, standard Email messages or a combination thereof. The messages can be received on any electronic device, preferably a wireless electronic device, most preferably a mobile or portable electronic device such as a computer, pager, cellular mobile telephone, personal digital device and the like. Cellular mobile telephones are the most preferred device for communications in a staggered electronic messaging campaign.

A Staggered Campaign comprises at least two advertisements. A staggered electronic marketing campaign having only a single advertisement would be a waste of resources. A Staggered Campaign preferably runs for more than one day prior to terminating. The maximum time a campaign runs is effectively unlimited, but preferably, the campaign runs for between 1 and 30 days, more preferably, at least two days but less than 24 days. In preferred embodiments staggered campaigns are run from one to 10 days, more preferably, two to seven days and most preferably from three to six days. It will be apparent that a campaign can run for almost any length of time, depending on the goals of the particular campaign. In some embodiments, the Staggered Campaign advertisements are fixed in number once the campaign is running; such a campaign is termed a “closed staggered campaign.” In other campaigns, additional advertisements may be added to the advertisements during the campaign period; such a campaign is termed an “open” campaign. The Campaign Control Program is functionalized to allow running open or closed staggered campaigns as desired. Most preferably, the Staggered Campaign is a closed campaign. While any number of advertisements can be sent by a staggered campaign, preferably, the number of advertisements per day is 2 to 24, more preferably, 2 to 12, and most preferably 2 to 5 advertisements per day. It will be understood that the number of advertisements sent to subscribers is related to the specific number of messages in a particular campaign and correlates with the time periods the program updates.

A staggered campaign can also be the basis for multiple, “nested”, staggered campaigns. That is, a staggered campaign whose initial or subsequent advertisements access, connect and send advertisements comprising additional staggered campaigns. Such a campaign is implemented by having the advertisements indicate that a response by a consumer/subscriber causes a first staggered campaign to run that links the subscriber to a campaign of advertisements each linked to another staggered campaign. Responding to multiple advertisements connects the subscriber/consumer to additional staggered campaigns imbedded in the initial staggered campaign. Such a campaign may connect a device user with a multiple number of advertising offers coming from a multiple number of staggered campaigns. Nested staggered campaigns may be an ideal method for advertisers to reach consumers on so-called “shopping holidays” without having to rely on location sensitive data (e.g. Global Position System data) to relay advertisement information.

Staggered campaigns can be programmed for consumers to receive advertisements in numerous ways provided the consumer receives all of the advertisements incorporated into a particular campaign. In one preferred embodiment, each message in a campaign is delivered at the same time on each successive day. In another preferred embodiment, each massage in a campaign is delivered to a consumer in relationship to the time the consumer joins a campaign. Subsequent campaign advertisements may be sent at the same or different times on the same or later days. Campaigns sending advertisements multiple times per day can be programmed to send advertisement messages based on the time a consumer joins a campaign, with subsequent advertisements being sent at each subsequent programmed advertisement time, or only at a specific time. Upon understanding the invention, it will become apparent to one of ordinary skill in the art that numerous advertising sequences and advertising messaging orders are possible.

In accordance to another embodiment of the present invention, there is provided a staggered campaign computer and network system 200 for providing advertisements to a mobile electronic device user. An exemplary system 200 is shown in FIG. 2. The system 200 comprises: a communications network 201 accessible by an electronic device 205 connected to the network 201; a campaign applications computer 202 or server comprising a marketing application program 203, the marketing application program 203 further comprising a staggered electronic marketing campaign application control program 204 configured to execute a staggered electronic marketing campaign through the communications network 201.

In accordance to an alternative embodiment, the network system 200 includes an aggregator 206 for collecting, coordinating and forwarding communications through an electronic device 205 to the campaign applications computer 202. In the present disclosure, the term “aggregator” is given it usual and accepted meaning in the communications art. In preferred embodiments, the network system 200 is configured to support messaging via a mobile device; preferably, the device is a wireless mobile device such as a cellular telephone. Most preferably, the wireless mobile device is a cellular telephone, a portable wireless network-connectable computer, pager, or other similar devices as recognizable to one of ordinary skill in the art. Preferably, the electronic device supports messaging via short message service messaging, multimedia messaging service messaging, or conventional Email messaging. Where the electronic device is a wireless mobile device, preferably the device is configured to support messaging via short message service messaging or multimedia messaging service messaging, or conventional Email messaging.

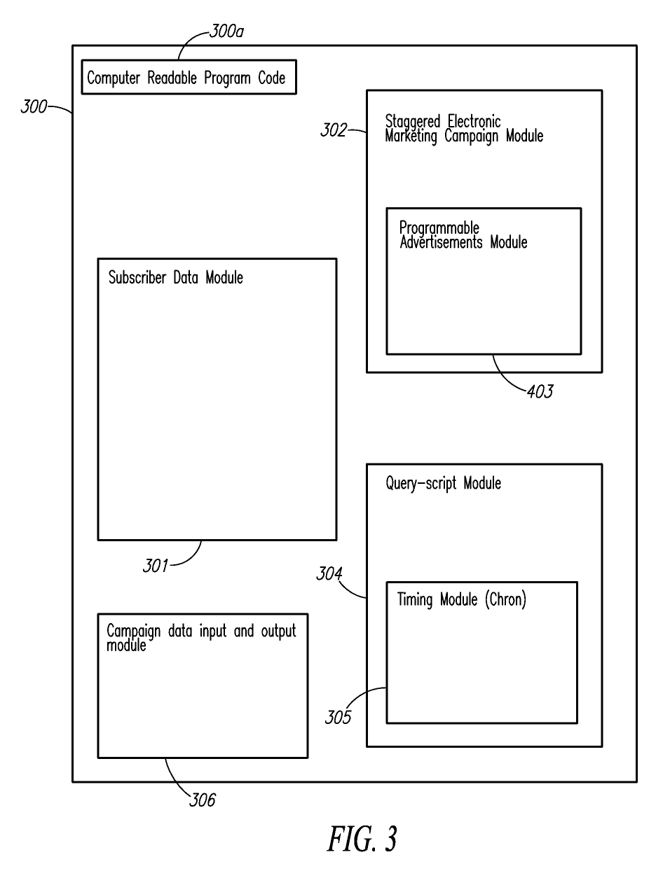

In accordance to still another embodiment of the present invention, there is provided a computer program product for delivering staggered electronic marketing campaigns for running on a general purpose electronic computer or specific electronic computer. This aspect of the invention is embodied in the form of a computer program product on a computer-usable or computer-readable storage medium having computer-usable or computer-readable program code embodied in the medium for use by, or in connection with, any general purpose computer instruction execution system (i.e. an “operating system”). FIG. 3 illustrates one preferred embodiment of a computer readable medium according to the present invention. Computer readable storage medium 300 has computer readable program code 300a embodied thereon. The computer readable storage medium 300 is divided into a plurality modules comprising: 1) a consumer/subscriber data module 301 for storing consumer/subscriber information; 2) a staggered electronic marketing campaign module 302, the staggered electronic marketing campaign module 302 comprising a programmable advertisements module 403 for storing the details of multiple programmable campaigns, each campaign having individual advertisements; 3) a Query-Script module 304, the Query-Script module 304 comprising a timing clock or chron module 305 for controlling the timing, updating and sequencing of staggered campaign advertisements in conjunction with campaign subscribers/consumers; and 4) a campaign data input and output module 306 for receiving message values from a consumer/subscriber and for sending staggered electronic marketing campaign advertisements to a consumer/subscriber through the network 200. A computer-usable or computer-readable medium for the purposed of this invention can be any medium that can contain, store, communicate, propagate, or transport the program for use by or in connection with the computer instruction execution system (operating system), apparatus, or device. The computer-usable product or computer-readable medium can be, but is not limited to an electronic, magnetic, optical, electromagnetic, infrared, or semiconductor system, apparatus, device, or other electromagnetic radiation propagation medium or system. A non-exhaustive list of computer-readable medium can include: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). The computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. The forgoing and other equivalent technology for programming a computer will be generally known and understood by those of ordinary skill in the art.

In certain embodiments, the programmable advertisements module comprises at least one set or list of advertisements. In another embodiment, the programmable advertisements module comprises code for at least one set of nested staggered campaigns, wherein “nested staggered campaigns” is meant that a consumer/subscriber who joins a first staggered campaign is presented with a campaign whose messages/advertisements connect to other staggered campaigns having at least two specific advertisements. Preferably, the program product is configured wherein the entry data module and the campaign data output module perform in wireless networks, more preferably in a short-text-message wireless network in conjunction with a portable or wireless cellular telephone. The modules are programmably interconnected to install, program, run and terminate staggered electronic marketing programming. The program can be incorporated with other general types of electronic programming to make a comprehensive suite of electronic marketing programs.

The following non-limiting examples are provided to further illustrate the practical applications of the staggered electronic marketing campaign. In each of the examples, the staggered campaign is run or executed according to the flow chart for a staggered electronic marketing campaign 100 illustrated in FIG. 1 via the staggered campaign applications computer 202 shown in FIG. 2.

### EXAMPLE 1

A staggered campaign named “Offers MB” having 4 advertisements running on consecutive days is joined by two different consumers at two different times. The campaign is programmed to run beginning with the first advertisement, which is sent by text message to a consumer on the first day following the day the consumer joins the campaign. The campaign is programmed for advertisement delivery in the campaign applications computer 202 in the marketing applications program 203 in the staggered electronic marketing campaign control program 204 as follows:

“Offers MB” Staggered Campaign Parameters and Advertisements”

Deliver messages requiring delivery at 10:00 AM Computer Clock (Chron 305); Update Time daily. Check for new Subscribers every 15 minutes. Deliver Day 1 message to Subscriber on one day after Subscriber joins Staggered Campaign “Offers MB”. Deliver subsequent messages one per day, each day of campaign at 10:00 AM until all messages delivered. Terminate campaign with notice to consumer with Day 4 message.

### Campaign “Offers MB” Advertisements

Day 1: offer for two-for-1 meal discount at a Joe's place restaurant.

Day 2: offer for 50% off discount waterslide tickets at Myrtle Beach Water-World.

Day 3: offer for half off miniature golf admission before 1:00 PM on any weekday.

Day 4: offer for 25 percent off beachwear on any Saturday or Sunday.

On Wednesday, Jun. 23, 2010 a consumer (P1) joined the “Offers MB” staggered campaign at 6:00 PM by texting “Offers MB” to number 75309. The offer is seen by a consumer/subscriber on a public billboard. When the system Chron 305 updates to add new campaign consumers (at 15 minute intervals), P1 is added to the campaign. On Thursday Jun. 24, 2010, at 10:00 AM the staggered campaign control program 204 indicates one new campaign member P1 and sends the Day 1 message by text to P1. On Thursday Jun. 24, 2010 at 1:00 PM, consumer P2 joins the campaign by texting “Offers MB” to number 75309. On Friday at 10:00 AM the staggered campaign control program 204 indicates one new campaign member P2 and one continuing member P1, wherein the program 204 determines that one Day 1 offer must be sent and one Day 2 offer must be sent since each consumer P1 and P2 joined the campaign. The program 204 sends the Day 1 message by text to P2 and the Day 2 message to P1. The sequence repeats until all four messages are sent to each consumer P1 and P2 joined to the campaign/network 201 and the program termination 60 notice sent, after which, the program 203 terminates.

### EXAMPLE 2

A staggered campaign stimulus for people interested in receiving advertising offers for golfers in the Myrtle Beach, S.C. area during a holiday week is made available to the public in a magazine article. The campaign comprises consumers texting the keyword “GOLF” to the number 91320. The staggered marketing campaign program comprises five opportunities for subscribers.

### Staggered Campaign Parameters and Advertisements

The campaign is programmed for advertisement delivery in the campaign applications computer 202 in the marketing applications program 203 in the staggered electronic marketing campaign control program 204 as follows: deliver offers to consumers twice per day, at 10:00 AM and 4:00 PM; begin offer delivery on the first system chron 305 update time, after a consumer joins the campaign; continue successive offer deliveries at each successive chron 305 update time, wherein offers are sent individually by text message, in the order listed, on subsequent chron 305 update times at 10:00 AM and 4:00 PM.

### Campaign Advertisements

1) offer free sleeve of golf balls for registering at “Golf-Land”;

2) offer free half-hour swing analysis with tee-time reservation after 1:00 PM any weekday at Ocean Aire Golf and Tennis Club;

3) offer free adult beverage at “19th Hole Pub” on showing a receipt for a round of 18 holes from local golf courses;

4) offer club cleaning kit with any full cost round of 18 holes at Dunes South Golf Course; and

5) offer for golf shoes cleaning and repair with any purchase of $40 or more at “The Golf Store”.

The campaign is programmed to send out the first advertisement on Jul. 1, 2010 at 10:00 AM to consumers who have joined the campaign prior. Three consumers join the campaign, (P1) at 7:00 AM on Jul. 1, 2010, (P2) at 3:00 PM on Jul. 1, 2010, (P3) at 5:00 PM on Jul. 1, 2010.

At 10:00 AM on July 1, P1 receives offer 1.

At 4 PM on July 1, the system chron 305 updates the campaign and finds an additional consumer added, P2. The campaign data input and output module 306 sends out offer 2 to P1 and offer 1 to P2.

At 10:00 AM on July 2, the system chron 305 updates the campaign and finds an additional consumer P3 is added. The campaign data input and output module 306 sends out offer 3 to P1, offer 2 to P2, and offer 1 to P3.

At 4:00 PM on July 2, the system chron 305 updates the campaign and finds no additional consumers added. The campaign data input and output module 306 sends out offer 4 to P1, offer 3 to P2, and offer 2 to P3.

At 10:00 AM on July 3, the system chron 305 updates the campaign and finds one additional consumer added. The campaign data input and output module 306 sends out offer 5 to P1, offer 4 to P2, offer 3 to P3 and offer 1 to P4.

At 4 PM on July 3, the system chron updates the campaign and finds no additional consumers added. The campaign data input and output module 306 sends out offer 5 to P2, offer 4 to P3 and offer 2 to P4. The campaign data input and output module 306 continues delivery of the 5 messages until each consumer has received all the messages. After each consumer receives all messages, the campaign terminates that consumer.

### EXAMPLE 3

### Nested Staggered Campaigns

A nested staggered campaign is defined as a staggered campaign programmed to comprise a multiple of staggered campaigns, each staggered campaign incorporating a number of separate advertisements.

### Campaign “Vacation Opportunities” Advertisements

1) Staggered Campaign comprising three offers for discounts on rounds of golf in Myrtle Beach;

2) Staggered Campaign comprising 4 offers for shopping discounts on Women's apparel at “Woman's World” department store; and

3) Staggered Campaign comprising four offers for local hotel and lodging discounts through the Chamber of Commerce.

Based on the design of the previously disclosed Examples 1 and Example 2, a staggered campaign of nested staggered campaigns is constructed so that each of the campaign text messages are for consumers to join three separate staggered campaigns having any desired number of messages. The text messages are sent to an electronic device 205 and on joining each campaign, the consumer is added to that particular staggered campaign. In this Example, a consumer responding to all three text messages in the nested campaign, “Vacation Opportunities”, will receive 9 offers from the 3 separate staggered campaigns.

It will be appreciated by those of skill in the art that a program and program product embodying staggered campaigns is programmable to host and run multiple campaigns at any given time. Additionally, it will be appreciated that the number of subscribers at any one time on a given campaign can be quite large; tens of thousands of subscribers may not be uncommon. Further, that staggered campaigns can be successfully integrated into programs and program products incorporating other types of compatible computer-based advertising campaigns such as the so-called “voting” or “scheduling” or other kind of computer-based advertising campaign and that combinations of such programs can be accomplished by one of ordinary skill in the art on understanding the presently disclosed invention.

It is envisioned that the various embodiments, as separately disclosed, are interchangeable in various aspects, so that elements of one embodiment may be incorporated into one or more of the other embodiments, and that specific positioning of individual elements may necessitate other arrangements not specifically disclosed to accommodate performance requirements or spatial considerations.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A computer-based method of advertising products and services to an electronic device user, comprising the steps of:
receiving a message-value from an electronic device;
matching the message-value to a corresponding staggered electronic marketing campaign;
creating a subscriber data profile corresponding to the mobile electronic device associated with the staggered electronic marketing campaign;
confirming receipt of the message value by sending a confirmation message to the electronic device;
sending campaign advertisements contained in the staggered electronic marketing campaign to the electronic device, and terminating contact with the electronic device at the end of the staggered electronic marketing campaign.

2. The method of claim 1, further comprising the step of:
sending advertising with the confirmation message.

3. The method of claim 1, wherein the message value comprises short message service messages, multimedia messaging service messaging, or a combination thereof.

4. The method of claim 1, wherein the message-value is received on a wireless network, and the confirmation message and the campaign advertisements are sent on the wireless network.

5. The method of claim 1, wherein the electronic device is a computer, a pager, or a cellular telephone.

6. The method of claim 1, wherein the staggered electronic marketing campaign comprises at least two advertisements.

7. The method of claim 1, wherein the staggered electronic marketing campaign runs for at least one day prior to terminating with the electronic device.

8. The method of claim 1, wherein the staggered electronic marketing campaign is closed.

9. The method of claim 1, wherein the staggered electronic marketing campaign is open.

10. The method of claim 1, wherein the staggered electronic marketing campaign further comprises at least one additional staggered electronic campaign imbedded or nested in the campaign advertisements.

11. A computer-based system for providing advertisements to an electronic device user, the system comprising:
a communications network accessible by an electronic device;
a campaign application server connected by a communications link to a communications network; and
a marketing application program residing on the campaign application server, the marketing application program comprising at least one staggered electronic marketing campaign control program configured to execute a staggered electronic marketing campaign.

12. The system of claim 11, further comprising an aggregator linking the communications network to the electronic device.

13. The system of claim 11, wherein the communications network comprises a wireless network.

14. The system of claim 11, wherein the communications network is configured to receive communications to and from a wireless electronic device.

15. The system of claim 14, wherein the wireless electronic device is a portable cellular phone, a pager, or a portable computer.

16. The system of claim 15, wherein the wireless electronic device is configured to support messaging by short message service messaging, multimedia messaging service messaging, or a combination thereof.

17. A computer program product for delivering an electronic marketing campaign on a network, the computer program product comprising:
a computer readable storage medium having a computer readable program code embodied thereon, the computer readable storage medium divided into a plurality of modules, the modules comprising:
a subscriber data module for receiving and storing a subscriber information;
a staggered electronic marketing campaign module for receiving and storing a staggered campaign parameters, the staggered electronic marketing campaign module comprising a programmable advertisements module;
a query module for determining and controlling the sending of advertisements, the query module comprising a programmable timing module; and
a campaign data input and output module for receiving message values from and sending staggered electronic marketing campaign advertisements to a subscriber.

18. The program product of claim 17, wherein the programmable advertisements module further comprises a memory function configured to contain at least one list of advertisements.

19. The program product of claim 17, wherein the programmable advertisements module further comprises at least one nested staggered electronic campaign imbedded in the primary staggered electronic campaign.

20. The program product of claim 17, wherein the program product is configured to run with a suite of computer-based advertising programs.
